(19) United States
(12) Patent Application Publication
(10) Pub. No.: US 2009/0278977 A1
(43) Pub. Date: Nov. 12, 2009

(54) METHOD AND APPARATUS PROVIDING PRE-DISTORTED SOLID STATE IMAGE SENSORS FOR LENS DISTORTION COMPENSATION

(76) Inventor: Jin Li, Meridian, ID (US)

Correspondence Address: DICKSTEIN SHAPIRO LLP, 1825 EYE STREET NW, Washington, DC, 20006-5403, US

(21) Appl. No.: 12/119,242

(22) Filed: May 12, 2008

(51) Int. Cl. G03B 13/00

(52) U.S. Cl. 348/345

(57) ABSTRACT

Pixels in an imaging array are configured and arranged to compensate for various geometric distortions caused by a lens with which the array is used.

### FIELD OF THE INVENTION

The invention relates to compensating for image distortion provided by a lens in an imaging system.

### BACKGROUND

Solid state imager circuits, e.g., CCD, CMOS, and others, include a focal plane array of pixels, each one of the pixels including a photosensor, for example, a photogate, photoconductor or a photodiode overlying a substrate for accumulating photo-generated charge in the underlying portion of the substrate.

FIG. 1 shows a grid layout for a conventional pixel array 100 of a solid state imager in which all of the pixels 104 and their respective photosensors are identically sized. Because the pixels 104 are identically sized and spaced, the lines connecting the pixels 104 to circuitry (not shown) located on the periphery of the pixel array 100 are also typically identically spaced.

In optics, a singlet lens is a lens consisting of a single simple element that may be used to focus an image onto a pixel array 100. Singlet lenses are prone to cause geometric distortions in an image reproduced by the pixel array 100 because of the non-linear contribution of light entering the singlet lens from various angles. Geometric distortion means that even if a perfect off-axis point image is formed, its location on the image plane is not correct. Distortion does not lower system resolution but instead causes an image shape to not correspond exactly to the shape of the imaged object. Distortion is a separation of the actual image point from the paraxially predicted location on the image plane and can be expressed either as an absolute value or as a percentage of the paraxial image height.

The effects of geometric lens distortion can be divided mainly into two different kinds of distortion, namely pincushion distortion and barrel distortion. FIG. 2A shows an object 300 made up of a grid, a singlet lens 304 focusing light 306 reflected from the object 300, and an image 302 of the object 300 as seen by a solid state sensor under the effects of pincushion distortion caused by the singlet lens 304. In pincushion distortion, image magnification increases with increasing distance from the optical axis. The apparent effect is that lines that do not go through the center of the image are bowed inwards, towards the centre of the image. FIG. 2B shows an object 300 made up of a grid, a singlet lens 304 focusing light 306 reflected from the object 300, and an image 308 of the object 300 as seen by a solid state image sensor under the effects of barrel distortion caused by the singlet lens 304. In barrel distortion, the image magnification decreases with increasing distance from the optical axis. The apparent effect is that of an image which has been mapped around a sphere.

Conventional solid state imaging devices have attempted to correct geometric distortion by using a doublet lens, or multi-piece lens, or through image processing. However, double lenses or multi-piece lenses are more complex and more expensive to manufacture than singlet lenses and image processing takes time and processing resources which may be better used by other processing tasks. Thus, there is a need and desire for relatively inexpensive image correction techniques that compensate for lens distortion.

### BRIEF DESCRIPTION OF THE DRAWINGS

FIG. 1 shows a grid arrangement for a conventional pixel array.

FIG. 2A shows an object, a lens, and an image of the object under the effects of pincushion distortion.

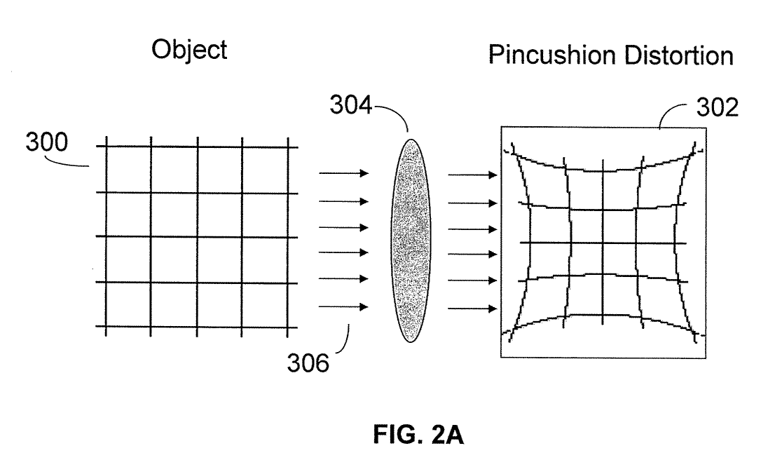

FIG. 2B shows an object, a lens, and an image of the object under the effects of barrel distortion.

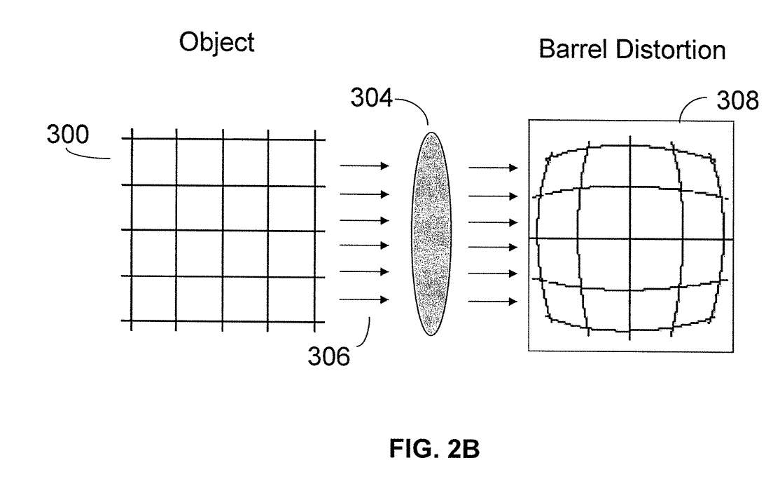

FIG. 3 shows a pixel array according to an embodiment described herein.

FIG. 4 shows a pixel array according to an embodiment described herein.

FIG. 5 shows a pixel array according to an embodiment described herein.

FIG. 6 shows a pixel according to an embodiment described herein.

FIG. 7 shows a pixel array according to an embodiment described herein.

FIG. 8 illustrates a block diagram of a CMOS imaging device constructed in accordance with an embodiment described herein.

FIG. 9 depicts a processor system, for example, a camera system constructed in accordance with an embodiment described herein.

### DETAILED DESCRIPTION

In the following detailed description, reference is made to the accompanying drawings which form a part hereof, and in which are shown by way of illustration of specific embodiments that may be practiced. These embodiments are described in sufficient detail to enable those of ordinary skill in the art to make and use them, and it is to be understood that structural, logical or procedural changes may be made to the specific embodiments disclosed herein.

Various embodiments described herein modify the location, size, and/or shape of pixels according to their spatial location in a pixel array to compensate for geometric distortions caused by a lens. The pixel array itself is thus distorted to correct for geometric distortions so that a captured image may be accurately reproduced. The embodiments described herein can thus limit or correct geometric distortions such as barrel distortion and pincushion distortion, as well as other geometric distortions. Thus, the cost of the lens may be lowered by using a simpler lens design, such as a singlet lens because geometric distortion is compensated for by the array configuration. Furthermore, other techniques for handling geometric lens distortion, such as after image capture processing, may be omitted.

It should be understood that where the specification refers to modifying pixel location, size, and/or shape what is most important is the location, size, or shape of the pixel photosensors in accordance with spatial location of a pixel in the array. Accordingly, when the discussion herein refers to changes in the location, size, or shape of the pixel, it is understood that the location, size, or shape of the photosensor changes proportionately to the change in the pixel location, size, or shape.

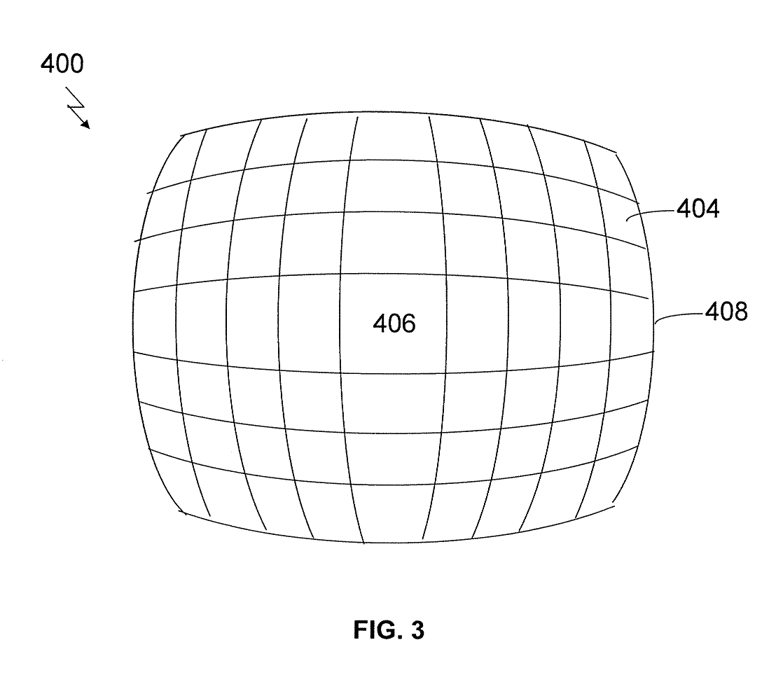

FIG. 3 shows an example of a pixel array 400 that has been pre-distorted to correct for barrel distortion which may be caused by a lens. Although the pixel array 400 shown in FIG. 3, and in all other embodiments described herein, is a simple array containing only seven columns and nine rows of pixels, it should be understood that the embodiments described herein may be applied to pixel arrays including any number of pixels, for example, a pixel array including hundreds or thousands of rows and hundreds or thousands of columns of pixels.

In one embodiment, the pixels 404 of the array 400 may have a size and shape that is varied according to the location of the pixels 404 within the array 400 to match the geometric distortion caused by the lens. As shown in FIG. 3, to correct barrel distortion, the pixels 404 may be shaped such that the pixels 404 have relatively straight edges at the center 406 and pixels 404 arranged closer to the edge 408 of the pixel array 400 have edges that are progressively more curved. The shape of the pixels 404 themselves are changed, which in turn, changes the overall shape of the pixel array 400 so that the pixel array 400 has sides that are curved in a convex manner. The size of the pixels shown in FIG. 3 also progressively decreases with position relative to the center of the pixel array 404. Because the pixels 404 are pre-distorted in size and shape to conform to the geometric distortion caused by the lens the final image will be free of distortion. Of course, the pixels 404 may be more or less curved and sized as needed to correct a particular barrel distortion caused by a lens.

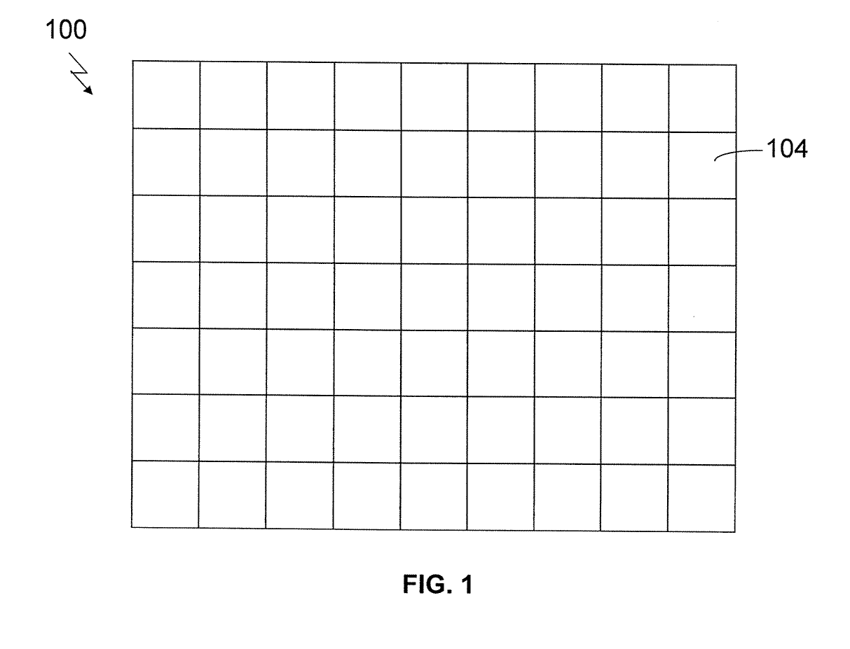

The shape of the pixel array 400 and the size and shape of the individual pixels 404 may be determined after a lens, e.g., a singlet lens, is selected for a particular application. A simulation for the geometric distortions may be preformed using optics simulation software (such as ZEMAX®, from ZEMAX Development Corporation). The pixel array 400 layout may be designed so that the individual pixels 402 are sized and shaped to match the geometric distortions caused by the lens and that would be seen in the image if a uniform pixel array, such as the one shown in FIG. 1, were used. The pre-distorted pattern of the pixel array 400 results in a captured image with reduced or no lens distortion.

In one embodiment, the size of the pixels 404 may be progressively changed such that the size of a pixel at the edge 408 of the array 400 may be about 5% to 15% smaller than the size of a pixel at the center 406 of the array 400. The variation in pixel size will depend on the amount of distortion caused by a particular lens. In another embodiment, the size of the pixels 404 may be progressively changed such that the size of a pixel at the edge 408 of the array 400 is 10% smaller than the size of a pixel at the center 406 of the array 400. The change in pixel size may also be accompanied by a change in pixel shape, or only pixel size or only pixel shape can be used to correct for lens distortion.

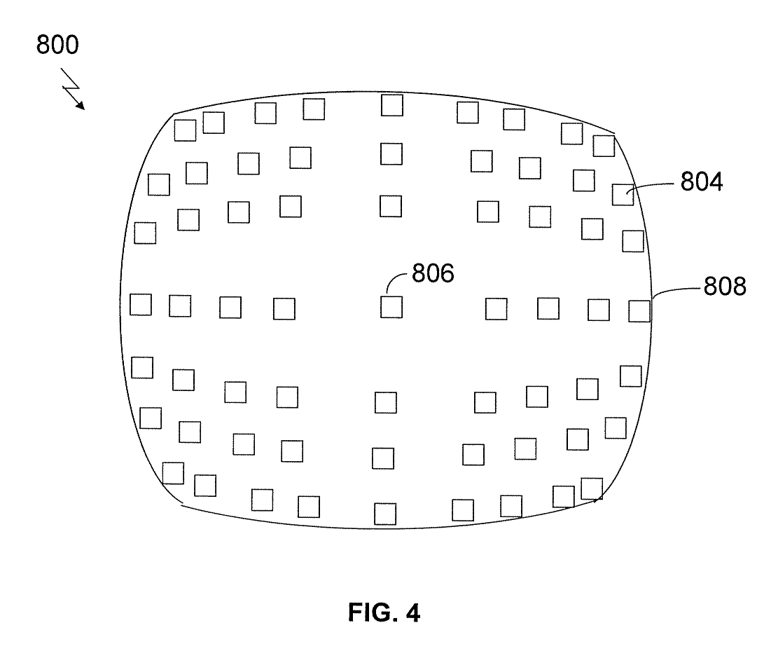

In another embodiment, as shown in FIG. 4, all of the pixels 804 of the array 800 may be the same size and shape, but are located and spaced apart in a pattern to correct the geometric distortion caused by a lens; e.g., in this embodiment, barrel distortion. In one embodiment, the pixels 804 may be conventional pixels employed in solid state imaging arrays but may be located and spaced apart from each other in a pattern determined by optics simulation software to correct the geometric distortion caused by a lens.

The location and spacing between the pixels 804 may be progressively changed such that the space between pixels at the edge 808 of the array 800 may be approximately 5% to 15% smaller than the space between pixels at the center 806 of the array 800. The variation in pixel location and spacing will depend on the amount of distortion caused by a particular lens. In another embodiment, the spacing between the pixels 804 may be progressively changed such that the space between pixels at the edge 808 of the array 800 is 10% smaller than the space between pixels at the center 806 of the array 800.

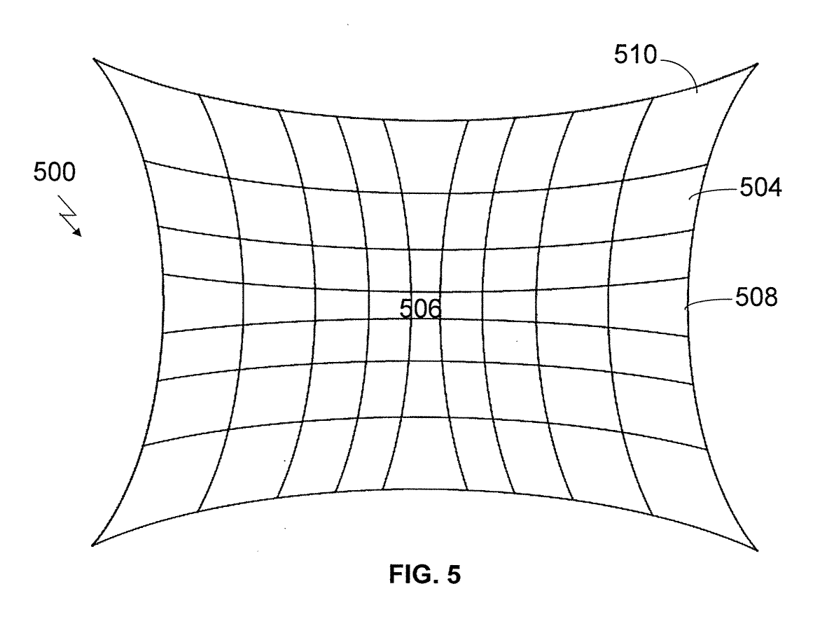

FIG. 5 shows a diagram of a pixel array 500 that has been distorted to correct for pincushion distortion cause by a lens. In one embodiment, the pixels 504 of the array 500 may have a size and shape that is varied according to the location of the pixels 504 within the pixel array 500 to match the pincushion distortion caused by the lens. The pixels 504 may be shaped such that the pixels 504 have relatively straight edges at the center 506 and pixels 504 arranged closer to the edge 508 of the pixel array 500 have edges that are progressively more curved. The shape of the pixels 504 themselves are changed, and this in turn, changes the overall shape of the pixel array 500 so that the pixel array 500 has sides that are curved in a concave manner. Because the pixels 504 are distorted to conform to the geometric distortion caused by the lens the final image will be largely free of distortion. The pixels may be changed in size alone, shape alone, or both size and shape to correct for lens distortion.

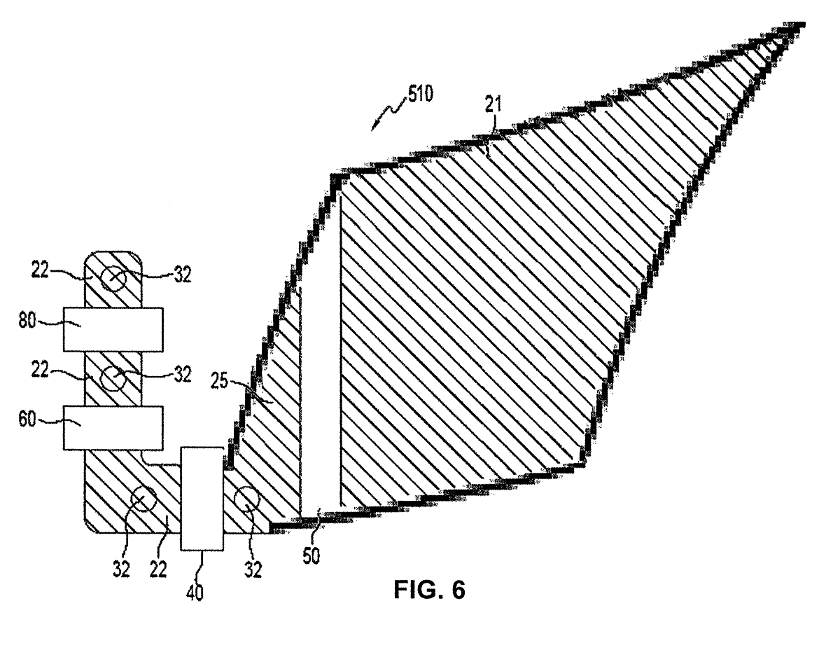

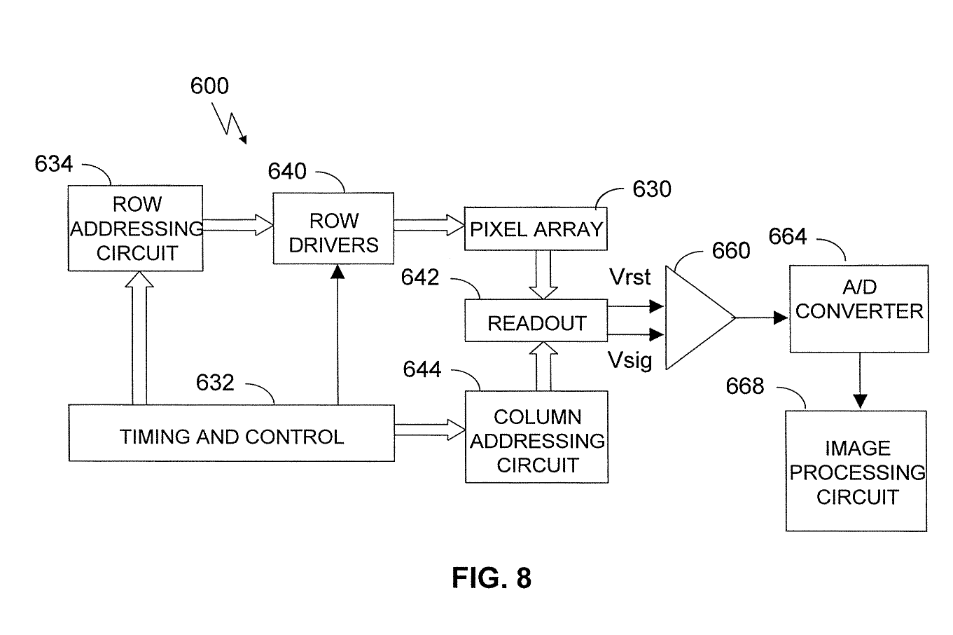

FIG. 6 shows a top down view of an individual four-transistor (4T) CMOS pixel 510 that may be used in a pixel array 500 (FIG. 5) of a CMOS imager, for example, the CMOS imager 600 illustrated in FIG. 8. The pixel has a photosensor 21 that has a size and shape determined by the pixel's location within the pixel array 500. The pixel 10 comprises a transfer gate 50 for transferring photoelectric charges generated in the photosensor 21 to a floating diffusion region 25 acting as a sensing node, which is in turn, electrically connected to the gate 60 of an output source follower transistor. A reset gate 40 is provided for resetting the floating diffusion region 25 to a predetermined voltage in order to sense a next signal, and a row select gate 80 is provided for outputting a signal from the source follower transistor to an output terminal in response to a pixel row select signal. The various transistors are coupled to each other via their source/drain regions 22 and coupled to other elements of an imaging device containing the pixel 510 via the contacts 32. The size and shape of the various transistors may be modified as needed to fit within the footprint shape of the pixel 510.

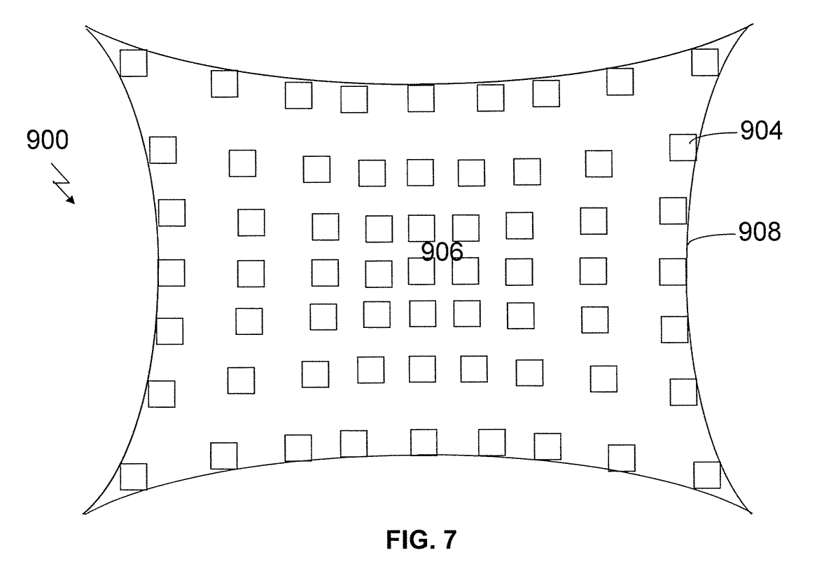

In another embodiment, shown in FIG. 7, all of the pixels 904 of the array 900 may be the same size and shape, but are located and spaced apart from each other in a pattern to correct the geometric pincushion distortion caused by a lens. In one embodiment, the pixels 904 may be conventional pixels employed in a solid state imager device, but may be spaced apart from each other in a pattern determined by the optics simulation software to correct the geometric distortion caused by a lens.

The spacing between the pixels 904 may be progressively changed such that the space between pixels at the edge 908 of the array 900 may be approximately 5% to 15% larger than the space between pixels at the center 906 of the array 900. The variation in the pixel spacing will depend on the amount of distortion caused by a particular lens. In one embodiment, the spacing between the pixels 904 may be progressively changed such that the space between pixels at the edge 908 of the array 900 is 10% larger than the space between pixels at the center 906 of the array 900.

Although various embodiments have been described as being useful to correct pincushion and barrel distortion, any spatially varying image problem caused by lens distortion can be corrected by changing the pixel location of spacing, shape, and/or size in accordance with the determined lens distortion.

FIG. 8 shows a block diagram of an imaging device 600, e.g. a CMOS imager that may include a pixel array 630 according to embodiments described herein. A timing and control circuit 632 provides timing and control signals for enabling the reading out of signals from pixels of the pixel array 630 in a manner commonly known to those skilled in the art. The pixel array 630 has dimensions of M rows by N columns of pixels, with the size of the pixel array 630 depending on a particular application.

Signals from the imaging device 600 are typically read out a row at a time using a column parallel readout architecture. The timing and control circuit 632 selects a particular row of pixels in the pixel array 630 by controlling the operation of a row addressing circuit 634 and row drivers 640. Signals stored in the selected row of pixels are provided to a readout circuit 642. The signals are read from each of the columns of the array sequentially or in parallel using a column addressing circuit 644. The pixel signals, which include a pixel reset signal Vrst and image pixel signal Vsig, are provided as outputs of the readout circuit 642, and are typically subtracted in a differential amplifier 660 and the result digitized by an analog to digital converter 664 to provide a digital pixel signal. The digital pixel signals represent an image captured by pixel array 630 and are processed in an image processing circuit 668 to provide an output image.

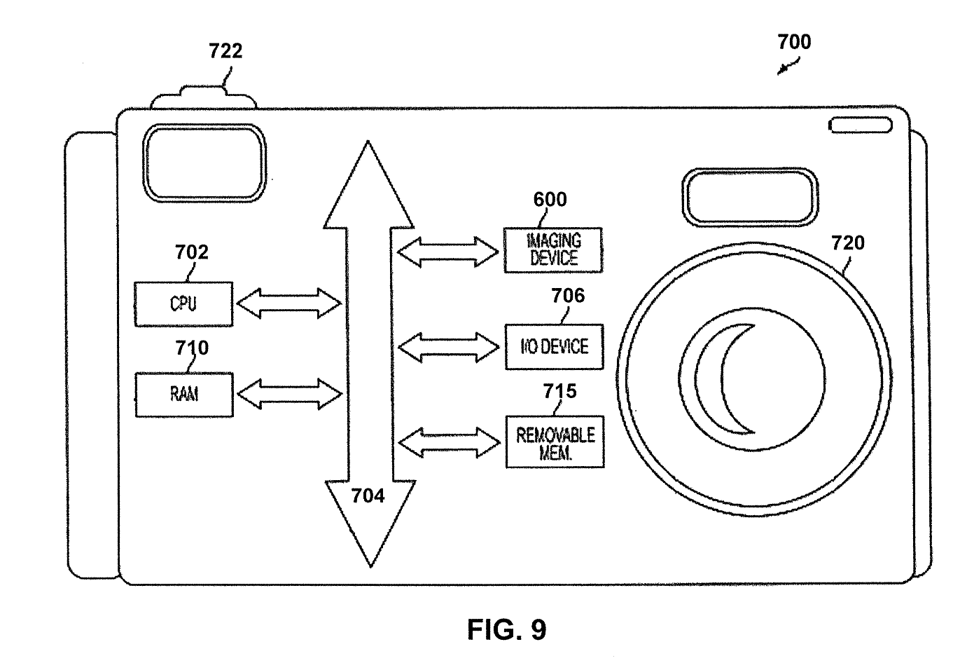

FIG. 9 shows a processor system 700 that includes an imaging device 600 having a pixel array 630 constructed and operated in accordance with the various embodiment described above. The processor system 700 is a system having digital circuits that include imaging device 600. Without being limiting, such a system could include a computer system, camera system, scanner, machine vision, vehicle navigation, video phone, surveillance system, auto focus system, star tracker system, motion detection system, image stabilization system, or other image acquisition system.

Processor system 700, for example a digital still or video camera system, generally comprises a central processing unit (CPU) 702, such as a control circuit or microprocessor for conducting camera functions, that communicates with one or more input/output (I/O) devices 706 over a bus 704. Imaging device 600 also communicates with the CPU 702 over the bus 704. The processor system 700 also includes random access memory (RAM) 710, and can include removable memory 715, such as flash memory, which also communicates with the CPU 1502 over the bus 704. The imaging device 600 may be combined with the CPU processor with or without memory storage on a single integrated circuit or on a different chip than the CPU processor. In a camera system, a lens 720 according to various embodiments described herein may be used to focus image light onto the pixel array 630 of the imaging device 600 and an image is captured when a shutter release button 722 is pressed.

While embodiments have been described in detail in connection with the embodiments known at the time, it should be readily understood that the invention is not limited to the disclosed embodiments. Rather, the embodiments can be modified to incorporate any number of variations, alterations, substitutions or equivalent arrangements not heretofore described without departing from the spirit or scope of the invention. For example, while some embodiments are described in connection with a CMOS pixel imaging device, they can be practiced with any other type of pixel imaging device (e.g., CCD, etc.) employing a pixel array. Accordingly, the invention is not limited by the forgoing description, but is only limited by the scope of the appended claims.

1. An imaging device, comprising:
a lens for focusing an image; and
a pixel array for capturing the image focused by the lens, and comprising a plurality of pixels, each pixel comprising a photosensor;
wherein the lens causes a geometrical distortion in the focused image by causing a shape of an object in the focused image to be different than the object's actual shape, and
wherein the pixel photosensors are arranged in the array to correct for geometrical distortion of the focused image captured by the pixel array.

2. The imaging device of claim 1, wherein the geometrical distortion is barrel distortion.

3. The imaging device of claim 2, wherein edges of the pixel array are curved in a convex manner.

4. The imaging device of claim 1, wherein the geometrical distortion is pincushion distortion.

5. The imaging device of claim 4, wherein edges of the pixel array are curved in a concave manner.

6. The imaging device of claim 1, wherein the size and shape of the pixels are changed according to the pixel's location within the pixel array to correct the geometrical distortion of the focused image.

7. The imaging device of claim 6, wherein the size of the photosensors decreases with distance from a center of the pixel array.

8. The imaging device of claim 6, wherein the size of the photosensors increases with distance from the center of the pixel array.

9. The imaging device of claim 1, wherein the size and shape of a plurality of photosensors are changed according to an associated pixel's location within the pixel array.

10. The imaging device of claim 1, wherein the distance between a first pixel and an adjacent pixel is changed according to the first pixel's location within the pixel array.

11. The imaging device of claim 1, wherein the distance between a photosensor of a first pixel and a photosensor of an adjacent pixel is changed according to the first pixel's location within the pixel array.

12. The imaging device of claim 11, wherein the distance between a first pixel and an adjacent pixel decreases according to the first pixel's distance from a center of the pixel array.

13. The imaging device of claim 11, wherein the distance between a first pixel and an adjacent pixel increases according to the first pixel's distance from a center of the pixel array.

14. The imaging device of claim 1, wherein the sides of pixels located farther from a center of the pixel array are curved more than the sides of pixels located closer to the center of the pixel array.

15. A camera system employing the imaging device of claim 1.

16. A pixel array comprising:
a plurality of pixels arranged in an array, each pixel comprising a photosensor,
the photosensors of the pixels having a changing physical characteristic according to the photosensors' location in said array to correct for geometrical distortion of a lens used with said array.

17. An imager employing the pixel array of claim 16.

18. The pixel array of claim 16, wherein the changing physical characteristic comprises a size and shape of the photosensors.

19. The pixel array of claim 16, wherein the changing physical characteristic comprises a distance between a photosensors of adjacent pixels.

20. A method of forming a pixel array comprising:
forming pixels in a pixel array in such a manner so as to correct a geometrical distortion of an image focused by a lens on the pixel array,
wherein the geometrical distortion causes a shape of an object in the focused image to be different than the object's actual shape.

21. The method of claim 20, wherein the geometric distortion comprises one of barrel distortion and pincushion distortion.

22. The method of claim 20, wherein the manner of forming the pixels comprises changing the size and shape of photosensors according to an associated pixel's location within the pixel array.

23. The method of claim 20, wherein the manner of forming the pixels comprises changing the distance between a photosensor of a first pixel and a photosensor of an adjacent pixel according to the first pixel's location on the pixel array.

24. A method of forming a pixel array, said method comprising:
analyzing a lens to determine geometrical distortions associated with said lens; and
fabricating a pixel array having geometric characteristics that correct for said distortions.

25. The method of claim 24, wherein the extent of the geometric distortions is determined by computer modeling.
